(19) United States
(12) Patent Application Publication
(10) Pub. No.: US 2006/0009866 A1
(43) Pub. Date: Jan. 12, 2006

(54) System for the generation of code

(76) Inventors: Marie-Catherine Fritsch, Schwanstetten (DE); Alfred Gleissner, Weiden (DE); Ronald Lange, Furth (DE); Soeren Moritz, Wimmelbach (DE); Amo Schonhals, Wendelstein (DE)

Correspondence Address: Siemens Corporatio;Intellectual Property Department, 170 Wood Avenue South, Iselin, NJ, 08830, US

(21) Appl. No.: 10/538,152

(22) PCT Filed: Oct. 30, 2003
(86) PCT No.: PCT/DE03/03614

§ 371 Date: Jun. 8, 2005

(30) Foreign Application Priority Data
Dec. 9, 2002 (DE) 102576122

(51) Int. Cl. G05B 19/42

(52) U.S. Cl. 700/86; 700/87; 700/52

(57) ABSTRACT

The invention relates to a system and a method whereby automation code is generated based on existing descriptions of a plant structure. The components of the plant are represented by functional modules and have ports for data transmission. Signals, allocated to the functional modules are transmitted via the ports. A signal can be allocated to more than one port, for example, because it denotes the currently active port. The signals are assigned meta-information. Automation code is automatically generated based on the configuration of the signals.

### CROSS REFERENCE TO RELATED APPLICATIONS

This application is the US National Stage of International Application No. PCT/DE2003/003614, filed Oct. 30, 2003 and claims the benefit thereof. The International Application claims the benefits of German application No. 10257612.2 filed Dec. 9, 2002, both applications are incorporated by reference herein in their entirety.

### FIELD OF THE INVENTION

The invention describes a system and a method for generating automation code from descriptions enriched with control-relevant information.

### SUMMARY OF THE INVENTION

In developing an automation system for a manufacturing or processing plant the continuity of the data or information flow is a problem. An automation system is generally described today with the aid of drawings. For this purpose CAD or CAE tools, for example, are used. On the basis of plant layouts described with such systems, information relevant to control and operation, such as material flow information, can be inserted in the drawing already produced. However, this information contained in the layout, i.e. in the graphic description of the plant, is currently not used directly for engineering an automation system. Although as a rule automation code is produced on the basis of the plant layout, continuity of data flow is not ensured.

As a rule a developer of an automation code receives a description of the plant layout, for example, in the form of a drawing, and converts this description into automation code on the basis of experience and programming guidelines, and in some cases with the aid of additional documentation. In isolated cases code is already generated from layout, but the methods are based on special reproductions and therefore cannot be implemented in a product to be used as a basic tool.

The interconnection of automation-relevant elements is currently effected via special connection points, a specific data transfer semantics being used for implementing the automation. However, a large number of further variants are relevant to the elaboration or reproduction of a directed relationship between the elements.

It is the object of the invention to specify a system and a method by means of which simpler generation of automation code is made possible.

This object is achieved by a system for generating automation code from descriptions enriched with control-relevant information, comprising components described in the descriptions, the components having ports and being represented by at least one functional module in each case, having input/output information on the ports reproduced from directed relationships between the components contained in the descriptions, having signals associated with the functional modules, the signals being provided for transmission via the ports of the components, and having means for defining metainformation for the signals and a code generator for producing automation code through interconnection of the signals.

In addition, the object is achieved by a method for generating automation code from descriptions enriched with control-relevant information, whereby components described in the descriptions are represented by at least one functional module in each case, and via ports input/output information on the ports is reproduced from directed relationships between the components contained in the descriptions, signals associated with the functional modules are transmitted via ports of the components, metainformation for the signals is defined and automation code is generated through interconnection of the signals.

The invention is based on recognition of the fact that the existing control-relevant information present in descriptions of a manufacturing or processing plant can be used advantageously for generating automation code. In this connection it is important to ensure a continuous data information flow from the compiling of a description to the generation of the corresponding automation code. In this way information is always available and cannot be lost in the course of producing an automation system.

In the system according to the invention data continuity is achieved in that control-relevant information is already contained in a description. The description, for example, of a plant, is produced with the aid of components representing the elements of which the plant consists. Within the system the components are represented in each case by so-called functional modules. These functional modules are objects of a particular type having characteristics and functions. These objects are reusable within the system. The components have connection points, called ports, via which data transfer is implemented in the finished automation system. In the system according to the invention information on the predecessor-successor relationships of the components in the plant is allocated to these ports. Signals are transmitted between the components via the ports. So-called metainformation is assigned to the signals, or the information is defined for the signals. The interconnection of the signals is executed on the basis of rules. With the aid of the metainformation a large number of variants for possible automation systems can be described, which variants can finally be used on the basis of the layout and in conjunction with the directed relationships between the components to generate automation code.

The metainformation specifies the possible relationships which can be established between components of the automation system. A more clearly focused specification can therefore be achieved on the basis of the metainformation, and the description of defined relationships between the components concerned can lead to automatic generation of code.

A further advantageous embodiment of the invention is characterized in that the system for generating automation code for manufacturing and/or processing plants is provided. It is especially advantageous that the complex production of automation code, which becomes correspondingly more difficult and error-prone as an automation system becomes larger, can be used in particular for the safety-relevant area of plant automation. Especially complex automation systems are generated precisely in the context of the automation of manufacturing and/or processing plants. In this respect it is a major advantage if a continuous information flow is ensured and if the automation system is generated for the most part automatically.

A further advantageous embodiment of the invention is characterized in that a drawing with control-relevant information is provided for use as description. In this case it is especially advantageous that, as a rule, the first step of an automation system is conceived in the form of a drawing. Graphic descriptions, as are present, for example, in a CAD system, can therefore be used with the inventive system for generating automation code.

A further advantageous embodiment of the invention is characterized in that fourth means are provided for inputting control-relevant information to be used as description. A description need not necessarily be present in the form of a drawing for the automation system. Rather, it may be present, for example, in tabular form or in any other form. What is decisive for the usability of a description is that the control-relevant information is entered in the description. If this is the case any description can be used as the basis for the system according to the invention.

A further advantageous embodiment of the invention is characterized in that a flow of material and/or energy and/or information in a manufacturing and/or processing plant is provided as the basis for reproducing the directed relationships between the components. The use of a material flow for describing the relationships of automation-relevant elements of a plant is especially advantageous since the overall concept for the creation of the plant is generally produced on the basis of the material flow in any case. The way in which materials are moved or passed through the plant is always immediately clear to an automation engineer. If the solution is developed on the basis of the material flow, therefore, the directed relationship between the elements involved can be established in a simple way. There is no need for further levels of abstraction, which could give rise to errors since the relationship between the elements involved is not immediately clear. Use of the material flow directly facilitates the work of an automation system developer because the-directed relationships can be defined intuitively.

In addition to the material flow, there are further “flows”, such as energy and information, in a plant to be designed. These, too, can be used as a basis for reproducing the directed relationships because they, too, are directed. In the planning of a plant these or any other “flows” are defined in the same way as a material flow. The components are incorporated in these flows, and interconnections as a basis for code generation between the components can be derived therefrom.

A further advantageous embodiment of the invention is characterized in that the generation of automation code for central and/or distributed automation systems is provided. In this respect it is advantageous that the code generated with the aid of the system and the method does not have to run on one controller but that the solution generated, i.e. the automation code, can be implemented on a plurality of controllers. The component-oriented code generation on the basis of the interconnection of the signals with the metainformation also makes possible a simple distribution of code components to a plurality of controllers, since the data flow at the ports is ensured by the metainformation in any case. The development of transfer protocols for communication is superfluous. In this way, decentralization of the automation systems developed is possible in a simple manner.

### BRIEF DESCRIPTION OF THE DRAWINGS

The invention is described and elucidated in more detail below with reference to the Figures, in which:

FIG. 1 is a schematic representation of a system for generating automation code,

FIG. 2 is an exemplary representation of the structure of controllers in a distributed automation system, and

FIG. 3 is an exemplary representation of the automatic networking of components in a distributed automation system.

### DETAILED DESCRIPTION OF THE INVENTION

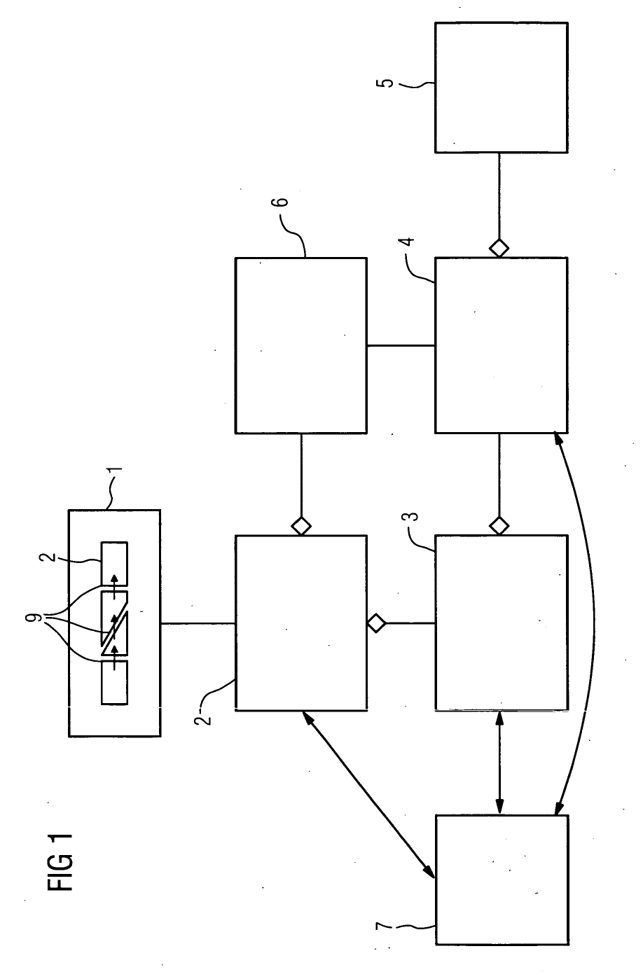

The system represented as an example in FIG. 1 generates code, in particular automation code, from descriptions 1. In the descriptions a complex structure, for example a plant, consists of individual components 2. The components 2 are represented by functional modules 3 and have ports 6. Signals 4 are sent via the ports 6. Metainformation is defined for the signals 4 with the aid of definition means 5. On the basis of the interconnection of the signals 4 code, in particular automation code, is generated by a code of generator 7.

Within the system according to the invention continuity of data flow is achieved in the engineering of an automation system. The automation-relevant information contained in a description, for example, a CAD drawing, is automatically used for the generation of automation code. The parts of a plant to be automated are contained in the description 1 as components 2 and possess automation-relevant information that is stored in the layout. The components 2 are represented by functional modules 3. As a rule one component 2 is represented by one functional module. In addition the components 2 include ports 6, i.e. inputs and outputs for data or signals. In the plant, communication between the components takes place via these ports 6. The information already contained in the description 1 is used to allocate input and output information to the ports. The predecessor-successor relationships between the components are governed by this information, i.e. who sends data to whom via which data input is defined thereby. The data is represented in the system by the signals 4. Via the input means 5 metainformation can be defined for these signals 4, which are transmitted via the ports 6 and are allocated to the respective functional modules 3 representing the corresponding components 2. The metainformation may be configured purely as additional information or as information relevant to the generation of code.

On the basis of the metainformation, the components 2 are connected to one another by automated means. Particular connections between the components 2 can only be implemented if this is permitted by the constraints described in the metainformation. Automated “wiring” of the components 2, and therefore automatic generation of automation code, are therefore effected.

The work of the development engineer is greatly facilitated thereby, since fewer degrees of freedom exist as a result of the definition of the metainformation, reducing the possibilities of error. In addition, a continuous information flow is ensured, reducing the loss of already established know-how during the development of the automation system.

Such descriptions may be, for example:

P7TE_OutputPS indicates that the parameter (valid only as an output value) must be connected to the input of a predecessor (a predecessor component) which has UDA P7TE_IPS with a value “S”.

On the basis of such stored rules the code is generated by means of an algorithm using a predecessor/successor principle, in particular when generating code for a central automation system.

The algorithm for connecting components on the basis of the predecessor/successor relationship may be, for example, as follows:
For all components (resources), the respective functional module is connected as follows:
   for all inputs of the functional module
   for all predecessors of the respective component
      Search for the outputs of the functional module of the predecessor which have a P7TE_OPS with a value “S”.
      Search for the inputs of the functional module of the current component which have a P7TE_IPS with a value “P”.
      Connect them if P7TE-NO matches (or does not exist in either, or is occupied or is defined)

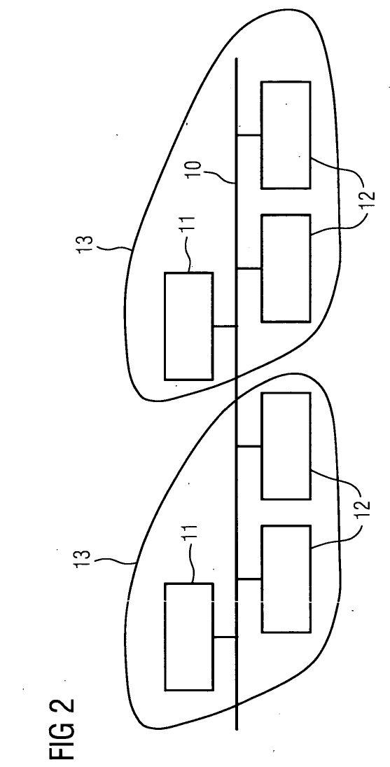

FIG. 2 shows the layout-oriented design of a structure of controllers with a communication network 10. This structure is the basis for the code generation in a distributed automation system. In the illustration an exemplary structure is represented by two zones 13, each of which must be controlled by a coordinating controller 11. A plurality of controllers for 12 the respective components 2 are activated by a higher-level, coordinating controller 11 via-the network 10, for example an Ethernet or PROFInet.

The code generator for a distributed system, for example for PROFInet, always starts from a structure in which at least one additional controller 11 is available for coordination. The allocation of the components 2 to this coordinating controller is effected graphically in the layout. In this case a network topology is designed.

Separate implementation of components responsible for correct data transmission or coordination between the coordinating controllers 12 is superfluous, since correct communication already exists as a result of the automation code generated automatically on the basis of the layout.

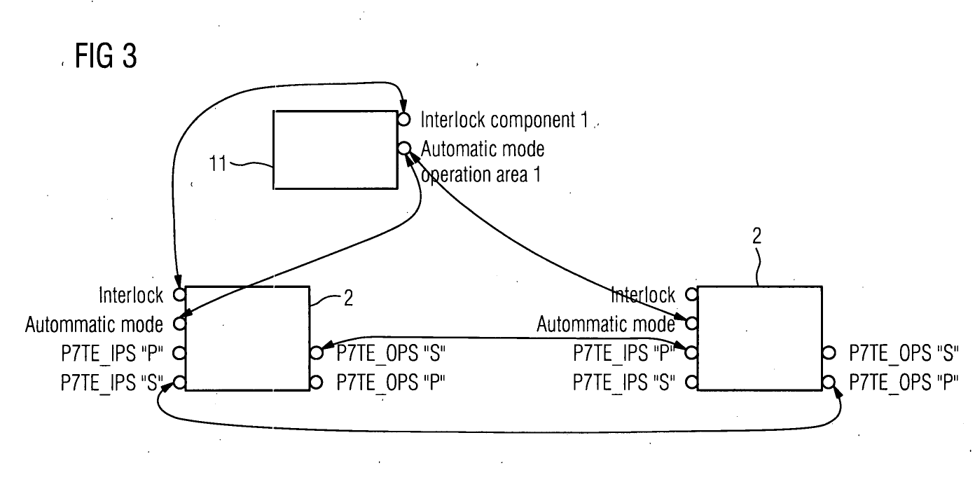

FIG. 3 shows the generation of automation code in a distributed automation system. The components 2 of a distributed automation system are connected, for example, according to the following algorithm or the following rules:

AutomaticMode/ManualMode

For these parameters the coordinating controller 11 has one output per operation area, which is assigned to this control field. The corresponding outputs are connected to the respective inputs.

ManualKeyInput/Interlock/ManualInterlock/AutomaticInter Lock

For this parameter the coordinating controller 11 has an individual output for each component 2, which output is connected to the respective input of the component 2.

P7TE_OPS/P7TE_IPS

The outputs of the components 2 are in each case connected to the corresponding inputs.

To sum up, the invention relates to a system and a method whereby automation code is generated on the basis of existing descriptions 1 of a plant structure. The components 2 of the plant are represented by functional modules 3 and have ports 6 for data transmission. Signals 4, allocated to the functional modules 3, are transmitted via the ports. A signal 4 may be allocated to more than one port, for example, because it identifies the currently active port 6. Metainformation is assigned to the signals 4. Automation code is automatically generated on the basis of the interconnection of the signals.

1.-12. (canceled)

13. A system for generating automation code from a description enriched with control-relevant information, wherein
in the description are components described, wherein the components having ports and being represented by at least one functional module, wherein
input/output information is mapped to the ports, wherein the input/output information stems from directed relationships between the components, wherein the input/output information is included in the description, wherein
signals provided for a transmission via the ports of the components are associated with the functional modules, the system comprising:
a first mechanism for defining metainformation for the signals; and
a code generator for generating automation code by interconnecting the signals.

14. The system according to claim 13, wherein the system is provided for generating automation code for manufacturing and/or processing plants.

15. The system according to claim 13, wherein a drawing having control-relevant information is provided as description.

16. The system according to claim 14, wherein a drawing having control-relevant information is provided as description.

17. The system according to claim 13, further comprising a mechanism for inputting control-relevant information for use as description.

18. The system according to claim 14, further comprising a mechanism for inputting control-relevant information for use as description.

19. The system according to claim 13, wherein a material flow, and/or energy flow, and/or information flow in a manufacturing and/or processing plant is provided as a basis for mapping the directed relationships between the components.

20. The system according to claim 14, wherein a material flow, and/or energy flow, and/or information flow in a manufacturing and/or processing plant is provided as a basis for mapping the directed relationships between the components.

21. The system according to claim 15, wherein a material flow, and/or energy flow, and/or information flow in a manufacturing and/or processing plant is provided as a basis for mapping the directed relationships between the components.

22. The system according to claim 17, wherein a material flow, and/or energy flow, and/or information flow in a manufacturing and/or processing plant is provided as a basis for mapping the directed relationships between the components.

23. The system according to claim 13, wherein the generation of automation code is provided for central and/or distributed automation solutions.

24. The system according to claim 14, wherein the generation of automation code is provided for central and/or distributed automation solutions.

25. The system according to claim 15, wherein the generation of automation code is provided for central and/or distributed automation solutions.

26. A method for generating automation code from at least one description enriched with control-relevant information, the method comprising:
representing components described in the descriptions by at least one functional block or building block, wherein a component having at least one port;
mapping input/output information regarding to the ports between the components, wherein the input/output information stems from directed relationships contained in the descriptions;
transmitting signals associated with the functional blocks or building blocks via the ports of the components;
defining metainformation for the signals; and
generating automation code by interconnecting the signals.

27. The method according to claim 26, wherein the automation code is generated for manufacturing and/or processing plants.

28. The method according to claim 26, wherein a drawing with control-relevant information is used as description.

29. The method according to claim 26, wherein control-relevant information is input as description.

30. The method according to claim 26, wherein a material and/or energy and/or information flow in a manufacturing and/or processing plant is used as a basis for mapping the directed relationships between the components.

31. The method according to claim 26, wherein automation code is generated for central and/or distributed automation systems.

32. A system for generating automation code from descriptions enriched with control-relevant information, comprising
components described in the descriptions, the components having ports and being represented in each case by at least one functional module,
input/output information on the ports reproduced from directed relationships between the components contained in the descriptions,
signals associated with the functional modules, the signals being provided for transmission via the ports of the components,
a first mechanism for defining metainformation for the signals, and
a code generator for producing automation code through interconnection of the signals.
